(19) United States
(12) Patent Application Publication
(10) Pub. No.: US 2009/0299523 A1
(43) Pub. Date: Dec. 3, 2009

(54) Walking robot and method of controlling the same

(75) Inventors: Hyun Kyu Kim, Seoul (KR); Woong Kwon, Seongnam-si (KR); Suk June Yoon, Seoul (KR); Kyung Shik Roh, Seongnam-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., Ltd., Suwon-si (KR)

(21) Appl. No.: 12/382,059

(22) Filed: Mar. 6, 2009

(30) Foreign Application Priority Data
Jun. 3, 2008 (KR) 10-2008-52179

(51) Int. Cl. G06F 19/00

(52) U.S. Cl. 700/245

(57) ABSTRACT

Disclosed are a biped walking robot, which carries out walking with a high energy efficiency through adjustment of the stiffnesses of joints of legs and improves walking stability through control of the pose of a torso, and a method of controlling the walking robot. The method includes generating a walking pattern of plural legs connected to a torso of the walking robot; adjusting stiffness of each of the plural legs interlocking with walking phases of the plural legs driven according to the walking pattern; and measuring a tilt of the torso, and compensating for the tilt of the torso such that the torso is parallel with the gravity direction.

### CROSS-REFERENCE TO RELATED APPLICATIONS

This application claims the benefit of Korean Patent Application No. 2008-0052179, filed Jun. 3, 2008, in the Korean Intellectual Property Office, the disclosure of which is incorporated herein by reference.

### BACKGROUND

1. Field

The present invention relates to a walking robot and a method of controlling the same, and more particularly to a walking robot with a plurality of legs, which walks erect using the plurality of legs, and a method of controlling the walking robot.

2. Description of the Related Art

In general, robots refer to machines, which conduct motions similar to those of a human. Early robots were industrial robots, such as manipulators or transfer robots for automation and unmanned operation of production work. Recently, a walking robot, which models the biped walking of a human, has been researched and developed. The biped walking has disadvantages, such as instability and difficulty in pose control or walking control, compared with the quadruped or hexapod walking, but has advantages, such as more flexibly coping with an uneven surface of the ground (i.e., a rugged road) or a discontinuous walking surface (for example, stairs).

The walking of a biped walking robot may be carried out by the following process. The biped walking robot predetermines a walking direction, a step length, a walking speed, etc., and generates a walking pattern of respective legs corresponding to the above predetermination to maintain the balance of the robot, and calculates walking trajectories of the respective legs according to the walking pattern. Further, the biped walking robot calculates positions of joints of the respective legs through inverse kinematics calculation of the calculated walking trajectories, and calculates target control values of motors of the respective joints based on current positions and target positions of the motors of the respective joints.

The biped walking is achieved through servo control to cause the respective legs to follow the calculated walking trajectories. Thus, it is detected whether or not the positions of the respective legs precisely follow the walking trajectories according to the walking pattern, and torques of the motors are adjusted such that the respective legs precisely follow the walking trajectories, when the respective legs are deviated from the walking trajectories.

In a conventional method of controlling the biped walking, servo control, in which walking trajectories are calculated whenever the walking robot walks, errors between the walking trajectories and positions of the respective legs are compensated for to follow the walking trajectories, is carried out, and thus power consumption is increased by continuous control during walking. Further, since the continuous control during walking increases the intrinsic frequency of the walking robot, the walking robot rapidly moves and thus does not walk naturally, or loses its balance when the ground, on which the walking robot walks, is inclined or uneven.

In order to solve the above problems, a method, in which a walking pattern meeting the intrinsic frequency of the walking robot is generated and stiffnesses of driving units to drive the legs interlocking with the walking pattern to perform the walking of the walking robot with a high energy efficiency, is used. That is, among joints of the legs, some joints, which do not require high stiffness, lower their stiffnesses such that a free motion due to inertia is achieved, and thus energy consumption required to maintain high stiffness is reduced.

However, in this case, when some joints of the two legs perform a motion due to inertia at low stiffness, the legs are deviated from the generated walking pattern due to the low stiffness of some joints, and the overall balance of the biped walking robot may be upset.

### SUMMARY

Therefore, it is an aspect of the present invention to provide a biped walking robot, which carries out walking with a high energy efficiency through adjustment of the stiffnesses of joints of respective legs and improves walking stability through control of the pose of a torso, and a method of controlling the walking robot.

Additional aspects and/or advantages will be set forth in part in the description which follows and, in part, will be apparent from the description, or may be learned by practice of the invention.

The foregoing and/or other aspects of the present invention are achieved by providing a method of controlling a walking robot, including generating a walking pattern of plural legs of the robot connected to a torso of the walking robot; adjusting respective stiffnesses of each of the plural legs interlocking with walking phases of the plural legs driven according to the walking pattern; and measuring a tilt of the torso, and compensating for the tilt of the torso such that the torso is parallel with a gravity direction.

In the compensation for the tilt of the torso, a tilt of a rolling axis of the torso and a tilt of a pitching axis of the torso may be compensated for.

The tilt of the torso may be measured using a pose sensor.

The adjustment of the stiffness of each of the plural legs may be represented by:

τ=J^{T}(K_{X}(X−X_{d})+D_{X}(X−X_{d}))

τ representing a torque of a joint of each of the plural legs, J representing a Jacobian of each of the plural legs, X_{d} representing target position and pose of each of the plural legs, X representing actual position and pose of each of the plural legs, and Kₓ and Dₓ respectively representing stiffness and damping matrix to the position and pose of each of the plural legs.

The foregoing and/or other aspects of the present invention are achieved by providing a method of controlling a walking robot, including generating walking factors of plural legs of the robot connected to a torso of the walking robot; generating a walking pattern satisfying a balance standard; adjusting respective stiffnesses of each of the plural legs interlocking with walking phases of the plural legs driven according to the walking pattern; measuring a tilt of the torso, and compensating for the tilt of the torso such that the torso is parallel with a gravity direction; calculating target torques of each of the plural legs; and controlling the each of the plural legs according to calculated torques.

In the compensation for the tilt of the torso, a tilt of a roll axis of the torso and a tilt of a pitch axis of the torso may be compensated for.

The tilt of the torso may be measured using a pose sensor.

The adjustment of the stiffness of each of the plural legs may be represented by:

τ=J^{T}(K_{X}(X−X_{d})+D_{X}(X−X_{d}))

τ representing a torque of a joint of each of the plural legs, J representing a Jacobian of each of the plural legs, X_{d} representing target position and pose of each of the plural legs, X representing actual position and pose of each of the plural legs, and Kₓ and Dₓ respectively representing stiffness and damping matrix to the position and pose of each of the plural legs.

In accordance with a further aspect, the present invention provides a walking robot including a walking pattern generating unit to generate a walking pattern of plural legs connected to a torso of the walking robot; a stiffness adjusting unit to adjust stiffness of each of the plural legs interlocking with walking phases of the plural legs driven according to the walking pattern; a pose sensor to measure a tilt of the torso; and a control unit to compensate for the tilt of the torso such that the torso is parallel with the gravity direction.

The control unit may compensate for a tilt of a roll axis of the torso and a tilt of a pitch axis of the torso to compensate for the tilt of the torso.

The adjustment of the stiffness of each of the plural legs may be represented by expression below,

τ=J^{T}(K_{X}(X−X_{d})+D_{X}(X−X_{d}))

τ representing a torque of a joint of each of the plural legs, J representing a Jacobian of each of the plural legs, X_{d} representing target position and pose of each of the plural legs, X representing actual position and pose of each of the plural legs, and Kₓ and Dₓ respectively representing stiffness and damping matrix to the position and pose of each of the plural legs.

### BRIEF DESCRIPTION OF THE DRAWINGS

These and/or other aspects and advantages of the invention will become apparent and more readily appreciated from the following description of the embodiments, taken in conjunction with the accompanying drawings in which:

FIG. 1 is a schematic view illustrating a walking robot in accordance with an embodiment of the present invention;

FIG. 2 is a view illustrating joint structures of the walking robot of FIG. 1;

FIG. 3 is a view illustrating a control system of the walking robot of FIG. 1;

FIGS. 4A to 4D are views respectively illustrating the control of the pose of a torso when the walking robot in accordance with the embodiment of the present invention walks on up and down slopes;

FIGS. 5A to 5D are views respectively illustrating the control of the pose of a torso when the walking robot in accordance with the embodiment of the present invention walks on side slopes;

FIG. 6 is a view illustrating a waist joint control system of the walking robot in accordance with the embodiment of the present invention; and

FIG. 7 is a flow chart illustrating a method of controlling a walking robot in accordance with an embodiment of the present invention.

### DETAILED DESCRIPTION OF EMBODIMENTS

Reference will now be made in detail to the embodiment, an example of which is illustrated in the accompanying drawings, wherein like reference numerals refer to like elements throughout. The embodiments described below to explain the present invention by referring to the annexed drawings.

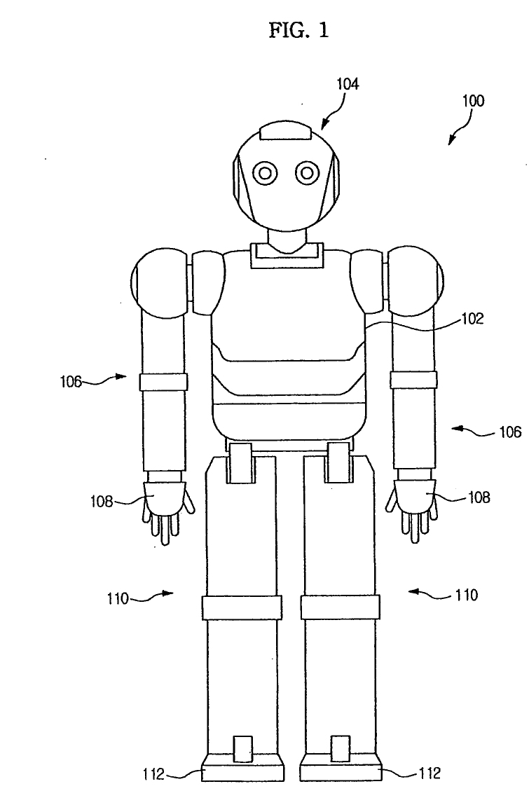

FIG. 1 is a schematic view illustrating a walking robot in accordance with an embodiment of the present invention. As shown in FIG. 1, a head 104 and two arms 106 are mounted on the upper portion of a torso 102 of a walking robot 100, and hands 108 are respectively mounted on tips of the two arms 106. Two legs 110 are mounted on the lower portion of the torso 102, and feet 112 are respectively mounted on tips of the two legs 110. The head 104, the two arms 106, the two legs 110, the two hands 108, and the two feet 112 respectively include joints to have designated degrees of freedom.

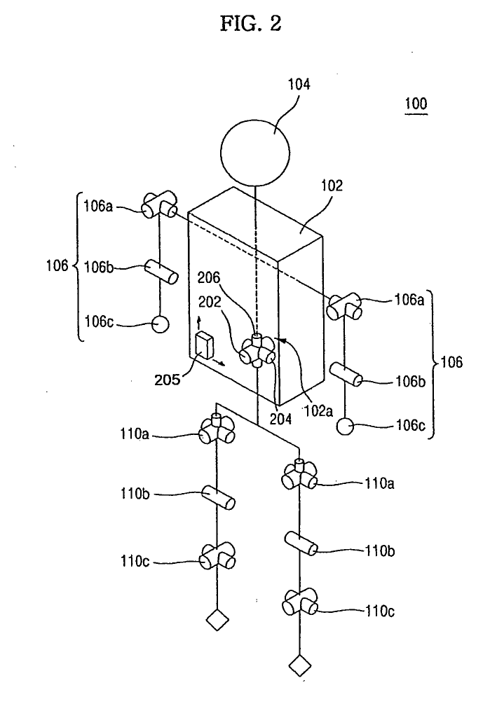

FIG. 2 is a view illustrating joint structures of the walking robot of FIG. 1. As shown in FIG. 2, the two arms 106 respectively include shoulder joints 106a, elbow joints 106b, and wrist joints 106c, and the two legs 110 respectively include thigh-joints 110a, knee joints 110b, and ankle joints 110c. The torso 102 includes a waist joint 102a.

Each of the thigh joints 110a of the legs 110 has a rolling axis, a pitch axis, and a yaw axis. Each of the knee joints 110b has a pitch axis. Each of the ankle joints 110c has a roll axis and a pitch axis.

The waist joint 102a provided in the torso 102 has a roll axis 202, a pitch axis 204, and a yaw axis 206. The roll axis 202 of the waist joint 102a allows the torso 102 to tilt right and left within a designated angle range, the pitch axis 204 of the waist joint 102a allows the torso 102 to tilt front and rear within a designated angle range, and the yaw axis 206 of the waist joint 102a allows the torso 102 to rotate right and left within a designated angle range.

The joints of the walking robot 100 are respectively operated by driving units (for example, electric driving units, such as motors).

A pose sensor 205 is installed on the torso 102 of the walking robot 100. The pose sensor 205 serves to detect a pose of the torso 102, and employs a gyro sensor, etc. The pose sensor 205 detects a tilt of the torso 102, and generates pose data. The pose data is used to control the balance of the walking robot 100 as well as the pose of the torso 102. The pose sensor 205 may be installed on the head 104 as well as the torso 102.

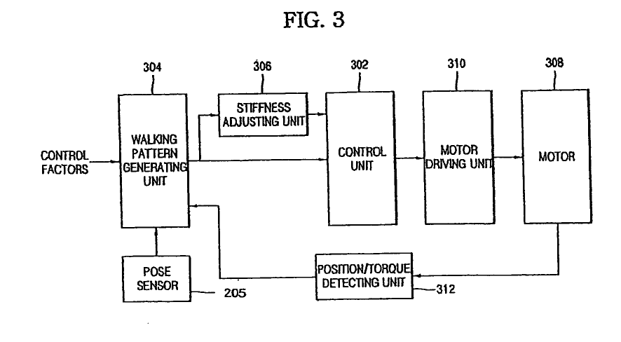

FIG. 3 is a view illustrating a control system of the walking robot in accordance with the embodiment of the present invention. As shown in FIG. 3, a walking pattern generating unit 304 and a stiffness adjusting unit 306 are communicably connected to the input side of a control unit 302 controlling the whole operation of the walking robot 100. Motors 308 to respectively move the joints and motor driving units 310 to drive the motors 308 are communicably connected to the output side of the control unit 302.

A position/torque detecting unit 312 detects positions and torques of the motors 308, and provides position/torque data to the walking pattern generating unit 304. The walking pattern generating unit 304 uses the position/torque data of the motors 308 to generate a walking pattern. Further, walking pattern generating unit 304 uses pose data supplied through the pose sensor 204 to generate the walking pattern.

The walking pattern generating unit 304 generates a walking pattern corresponding to control factors determining target walking direction, step length, and walking speed of the walking robot 100, and generates a phase signal of a frequency corresponding to the walking pattern. Here, the walking pattern is generated in real time during walking as well as in the initial stage of walking. The phase signal generated by the walking pattern generating unit 304 is a signal to drive the respective legs 110 in various phases.

The walking pattern generated by the walking pattern generating unit 304 is inputted to the stiffness adjusting unit 306. The stiffness adjusting unit 306 adjusts stiffnesses of the respective joints based on the driving states of the respective legs 110 according to the walking pattern. The control unit 302 of the walking robot 100 in accordance with an embodiment of the present invention controls the respective joints such that corresponding joints maintain high stiffnesses only when high stiffness is required according to the walking pattern and the stiffnesses of the joints are lowered in other cases, thereby maintaining balance in gravity and inertia and thus allowing the walking robot 100 to naturally and effectively walk. The adjustment of the stiffness of each of the two legs of the walking robot 100 in accordance with the embodiment of the present invention is represented by expression below.

τ=J^{T}(K_{X}(X−X_{d})+D_{X}(X−X_{d}))

In the expression above, τ represents a torque of a joint of each of the plural legs, J represents a Jacobian of each of the plural legs, X_{d} represents target position and pose of each of the plural legs, X represents actual position and pose of each of the plural legs, and Kₓ and Dₓ respectively represent stiffness and damping matrices to the position and pose of each of the plural legs.

For example, while one leg of the two legs 110 moves, the other leg must support the overall load of the walking robot 100 and the leg supporting the load must maintain a high stiffness. When the calf portion of the moving leg below the knee joint 110b swings like a pendulum after standing tiptoe, the calf portion is not greatly deviated from the walking trajectory on the moving state due to gravity and inertia, and thus the stiffness of the moving leg is lowered. As described above, the walking robot 100 in accordance with the embodiment of the present invention adjusts stiffnesses of the respective joints according to driving states of the respective legs 110 while walking, and thus reduces servo control amounts of the driving motors 308, thereby providing a high walking efficiency. Here, the high walking efficiency means that energy consumed while walking is reduced. That is, some joints, which do not require high stiffness while walking, lower their stiffnesses, and thus energy consumption can be reduced to that extent.

When the stiffnesses of the joints of the legs are adjusted according to the walking phases, as described above, the pose of the torso 102 must be considered in order to maintain the balance of the walking robot 100 in a more stable state. Particularly, in case that the walking robot 100 walks on an uneven road or a slope, the control of the balance of the walking robot 100 in consideration of the pose of the torso 102 is more important.

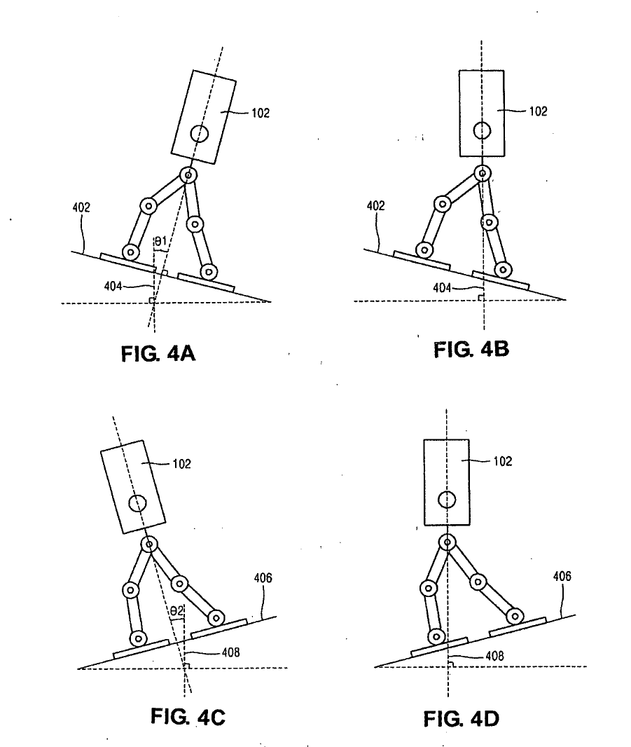

FIGS. 4A to 4D are views respectively illustrating the control of the pose of the torso 102 when the walking robot 100 in accordance with the embodiment of the present invention goes up and down slopes. FIG. 4A illustrates the tilting of the torso 102 when the walking robot 100 goes up a slope 402. As shown in FIG. 4A, when the walking robot 100 goes up the slope 402 with the same walking pattern as that on the level ground, the torso 102 is perpendicular to the slope 402, on which the walking robot 100 walks now, but is tilted backward from the gravity direction 404 at an angle of θ1. In this embodiment of the present invention, the pose of the torso 102 is controlled such that the direction of the torso 102 is parallel with the gravity direction 404, when the walking robot 100 goes up the slope 402, as shown in FIG. 4B. Thereby, the center of gravity of the walking robot 100, tilted backward, moves relatively forward, and thus the stability of the walking robot 100 is enhanced.

FIG. 4C illustrates the tilting of the torso 102 when the walking robot 100 goes down a slope 406. As shown in FIG. 4C, when the walking robot 100 goes down the slope 406 with the same walking pattern as that on the level ground, the torso 102 is perpendicular to the slope 406, on which the walking robot 100 walks now, but is tilted forward from the gravity direction 408 at an angle of θ2. In this embodiment of the present invention, the pose of the torso 102 is controlled such that the direction of the torso 102 is parallel with the gravity direction 408, when the walking robot 100 goes down the slope 406, as shown in FIG. 4D. Thereby, the center of gravity of the walking robot 100, tilted forward, moves relatively backward, and thus the stability of the walking robot 100 is enhanced.

In FIGS. 4A to 4D, θ0 and θ2 are tilt angles (θ_pitch) of the pitching axis 204 of the waist joint 102a against the gravity direction and when θ1 of FIG. 4A has a positive value, θ2 of FIG. 4C has a negative value.

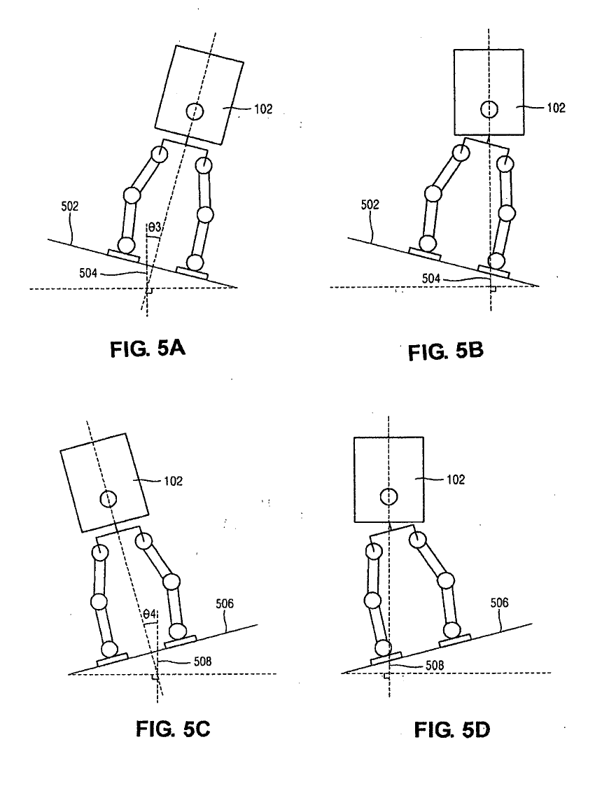

FIGS. 5A to 5D are views respectively illustrating the control of the pose of the torso 102 when the walking robot 100 in accordance with the embodiment of the present invention walks on side slopes. FIG. 5A illustrates the tilting of the torso 102 when a higher region of a slope 502 is located at the right of the walking robot 100. As shown in FIG. 5A, when the walking robot 100 walks on the slope 502 with the same walking pattern as that on the level ground, the torso 102 is perpendicular to the slope 502, on which the walking robot 100 walks now, but is tilted to the left from the gravity direction 504 at an angle of θ3. In this embodiment of the present invention, the pose of the torso 102 is controlled such that the direction of the torso 102 is parallel with the gravity direction 504, when the walking robot 100 walks on the slope 502, as shown in FIG. 5B. Thereby, the center of gravity of the walking robot 100, tilted to the left, moves relatively to the right, and thus the stability of the walking robot 100 is enhanced.

FIG. 5C illustrates the tilting of the torso 102 when a higher region of a slope 506 is located at the left of the walking robot 100. As shown in FIG. 5C, when the walking robot 100 walks on the slope 506 with the same walking pattern as that on the level ground, the torso 102 is perpendicular to the slope 506, on which the walking robot 100 walks now, but is tilted to the right from the gravity direction 508 at an angle of θ4. In this embodiment of the present invention, the pose of the torso 102 is controlled such that the direction of the torso 102 is parallel with the gravity direction 508, when the walking robot 100 walks on the slope 506, as shown in FIG. 5D. Thereby, the center of gravity of the walking robot 100, tilted to the right, moves relatively to the left, and thus the stability of the walking robot 100 is enhanced.

In FIGS. 5A to 5D, θ3 and θ4 are tilt angles (θ_roll) of the rolling axis 202 of the waist joint 102a against the gravity direction, and when θ3 of FIG. 5A has a positive value, θ4 of FIG. 5C has a negative value.

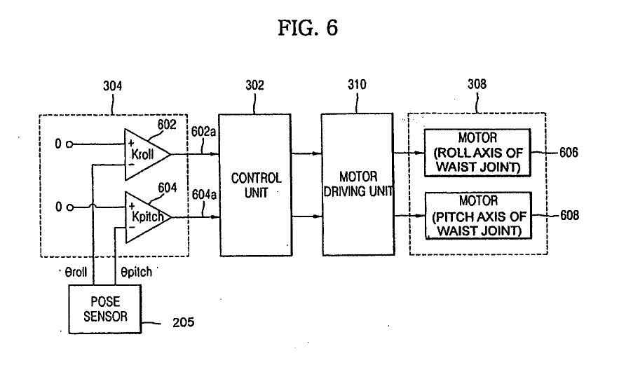

FIG. 6 is a view illustrating a waist joint control system of the walking robot in accordance with the embodiment of the present invention. As shown in FIG. 6, the walking pattern generating unit 304 calculates compensation values to compensate for the pose of the torso 102 measured by the pose sensor 205, particularly the tilt angle (θ_roll) of the torso 102 in the roll direction and the tilt angle (θ_pitch) of the torso 102 in the pitch direction, and generates control data to control the pose of the torso 102 such that the torso 102 is parallel with the gravity direction, based on the calculated values.

A first comparator 602 of the walking pattern generating unit 304 generates a roll axis control data 602a, which has the same size as of the tilt angle (θ_roll) of the torso 102 in the roll direction supplied from the pose sensor 204 and the contrary value of the tilt angle (θ_roll) of the torso 102 in the roll direction, and a second comparator 604 of the walking pattern generating unit 304 generates a pitch axis control data 604a, which has the same size as the tilt angle (θ_pitch) of the torso 102 in the pitch direction supplied from the pose sensor 204 and the contrary value of the tilt angle (θ_pitch) of the torso 102 in the pitch direction. The control unit 302 controls the motor 606 of the roll axis 202 of the waist joint and the motor 608 of the pitch axis 204 of the waist joint through the motor driving unit 310 based on the roll axis control data 602a and the pitch axis control data 604a, thus allowing the torso 102 to be parallel with the gravity direction without tilting.

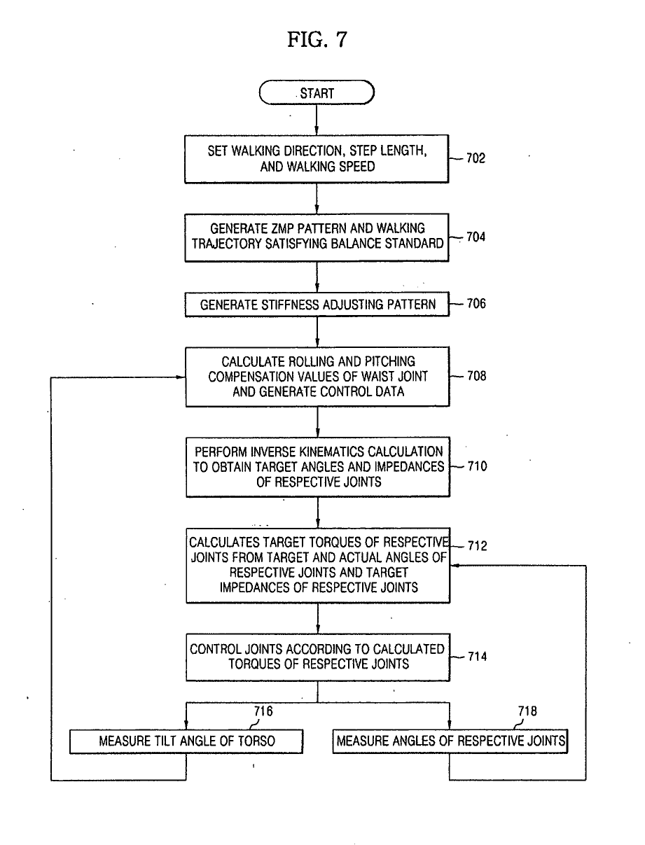

FIG. 7 is a flow chart illustrating a method of controlling a walking robot in accordance with an embodiment of the present invention. As shown in FIG. 7, the control unit 302 sets control factors, such as a walking direction, a step length, and a walking speed of the walking robot 100 (operation 702). The walking pattern generating unit 304 generates a ZMP pattern satisfying the balance standard of the walking robot 100 and a walking trajectory satisfying the ZMP pattern using the control factors, measured values of the pose sensor 204 and position/torque data of the motors 308 fed back through the position/torque detecting unit 312 (operation 704). That is, the walking pattern generating unit 304 generates a walking pattern. The stiffness adjusting unit 306 generates a stiffness adjusting pattern corresponding to the generated walking pattern (operation 706).

The walking pattern generating unit 304 calculates rolling and pitching compensation values to compensate for the tilt angles of the waist joint 102a, and generates control data to control the pose of the torso 102 such that the torso 102 is parallel with the gravity direction, based on the calculated values (operation 708). In the initial stage of walking, the torso 102 of the walking robot 100 is not tilted, and thus the rolling and pitching compensation values in this stage are zero. The walking pattern generated by the walking pattern generating unit 304 and the stiffness adjusting pattern generated by the stiffness adjusting unit 306 are inputted to the control unit 302, and the control unit 302 performs inverse kinematics calculations to obtain angles and impedances to control the motors of the respective joints (operation 710). In order to drive the respective joints necessary for walking, target torques of the respective joints need to be calculated. For this reason, the control unit 302 calculates target torques of the respective joints from target and actual angles of the respective joints and target impedances of the respective joints (operation 712). The control unit 302 controls the respective joints according to the calculated torques of the respective joints (operation 714). Thereby, the walking of the walking robot 100 is achieved.

Above operation 708 to calculate rolling and pitching compensation values of the waist joint 102a and generate control data of the waist joint 102a requires data regarding the tilt angle of the torso 102. Thus, the tilt angle of the torso 102 during walking of the walking robot 100 is measured, and is fed back to the walking pattern generating unit 304 (operation 716). In the initial stage of walking, the tilt angle of the torso 102 is zero. In case that the walking robot 100 walks on an inclined surface or an uneven surface of the ground, when stiffnesses of some joints of the two legs are adjusted such that an inertia motion is performed, the torso 102 is tilted to front and rear or right and left due to the grade or uneven state of the surface of the walking region. Operation 716 to measure the tilt angle of the torso 102 is performed to compensate for the tilt of the torso 102, in this case.

While the walking robot 100 walks, in order to control the respective joints in real time, the current angles of the respective joints are calculated, and are fed back to above-described operation 712 to calculate the target torques of the respective joints (operation 718).

As apparent from the above description, the present invention provides a biped walking robot, which carries out walking with a high energy efficiency through adjustment of the stiffnesses of joints of legs and improves walking stability through control of the pose of a torso, and a method of controlling the walking robot.

Although embodiments of the invention have been shown and described, it would be appreciated by those skilled in the art that changes may be made in these embodiments without departing from the principles and spirit of the invention, the scope of which is defined in the claims and their equivalents.

What is claimed is:

1. A method of controlling a walking robot, comprising:
generating a walking pattern of plural legs of the robot connected to a torso of the walking robot;
adjusting respective stiffnesses of each of the plural legs interlocking with walking phases of the plural legs driven according to the walking pattern; and
measuring a tilt of the torso, and compensating for the tilt of the torso such that the torso is parallel with a gravity direction.

2. The method according to claim 1, wherein the compensating for the tilt of the torso comprises compensating for a tilt of a roll axis of the torso and a tilt of a pitch axis of the torso.

3. The method according to claim 1, wherein the measuring the tilt of the torso comprises using a pose sensor.

4. The method according to claim 1, wherein the adjusting the respective stiffnesses of each of the plural legs is performed according to,
τ=J^{T}(K_{X}(X−X_{d})+D_{X}(X−X_{d}))
τ representing a torque of a joint of each of the plural legs, J representing a Jacobian of each of the plural legs, X_{d} representing a target position and pose of each of the plural legs, X representing an actual position and pose of each of the plural legs, and Kₓ and Dₓ respectively representing stiffness and damping matrix to the position and pose of each of the plural legs.

5. A method of controlling a walking robot, comprising:
generating walking factors of plural legs of the robot connected to a torso of the walking robot;
generating a walking pattern satisfying a balance standard;
adjusting respective stiffnesses of each of the plural legs interlocking with walking phases of the plural legs driven according to the walking pattern;
measuring a tilt of the torso, and compensating for the tilt of the torso such that the torso is parallel with a gravity direction;
calculating target torques of each of the plural legs; and
controlling the each of the plural legs according to calculated torques.

6. The method according to claim 5, wherein the compensating for the tilt of the torso comprises compensating for a tilt of a roll axis of the torso and a tilt of a pitch axis of the torso.

7. The method according to claim 5, wherein the measuring the tilt of the torso comprises using a pose sensor.

8. The method according to claim 5, wherein the adjusting the respective stiffnesses of each of the plural legs is performed according to,
τ=J^{T}(K_{X}(X−X_{d})+D_{X}(X−X_{d}))
τ representing a torque of a joint of each of the plural legs, J representing a Jacobian of each of the plural legs, X_{d} representing a target position and pose of each of the plural legs, X representing an actual position and pose of each of the plural legs, and Kₓ and Dₓ respectively representing stiffness and damping matrix to the position and pose of each of the plural legs.

9. A walking robot comprising:
a torso;
a plurality of legs, connected to the torso;
a walking pattern generating unit to generate a walking pattern of the plurality of legs;
a stiffness adjusting unit to adjust a respective stiffness of each of the plurality of legs interlocking with walking phases of the plural legs driven according to the walking pattern;
a pose sensor to measure a tilt of the torso; and
a control unit to compensate for the tilt of the torso such that the torso is parallel with a gravity direction.

10. The walking robot according to claim 9, wherein the control unit compensates for a tilt of a roll axis of the torso and a tilt of a pitch axis of the torso to compensate for the tilt of the torso.

11. The walking robot according to claim 9, wherein the adjustment of the stiffness of each of the plural legs is performed according to,
τ=J^{T}(K_{X}(X−X_{d})+Dₓ(X−X_{d}))
τ representing a torque of a joint of each of the plural legs, J representing a Jacobian of each of the plurality of legs, X_{d} representing a target position and pose of each of the plural legs, X representing an actual position and pose of each of the plural legs, and Kₓ and Dₓ respectively representing stiffness and damping matrix to the position and pose of each of the plural legs.
